(19) United States
(12) Patent Application Publication
(10) Pub. No.: US 2007/0111628 A1
(43) Pub. Date: May 17, 2007

(54) Method for manufacturing electron-emitting device and method for manufacturing display having electron-emitting device

(75) Inventors: Takao Yagi, Kanagawa (JP); Motohiro Toyota, Kanagawa (JP); Toshiki Shimamura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/555,182

(22) PCT Filed: May 7, 2004
(86) PCT No.: PCT/JP04/06474

§ 371 Date: Jan. 3, 2007

(30) Foreign Application Priority Data
May 8, 2003 (JP) 2003-129965

(51) Int. Cl. H01J 9/24; H01J 9/00

(52) U.S. Cl. 445/24; 445/50

(57) ABSTRACT

In removing a protection film, damage to an emitter material (carbon nanotubes) is decreased.

A process for manufacturing an electron emitting device includes a first step of forming an emitter layer 10 containing carbon nanotubes 11 as a fibrous emitter material on a cathode electrode 5, a second step of forming an insulating layer 6 and a gate electrode 7 on the emitter layer 10 through a protection film 22, a third step of forming gate holes 8 in the insulating layer 6 and the gate electrode 7 above the emitter layer 10, and a fourth step of removing the protection film 22, which was exposed by forming the gate holes 8, with a weak acid etchant.

### TECHNICAL FIELD

The present invention relates to a process for manufacturing an electron emitting device and a process for manufacturing a display including an electron emitting device.

### BACKGROUND ART

When an electric field of a certain threshold or more is applied to a surface of a metal conductor or a semiconductor placed in a vacuum, electrons pass through a barrier due to a tunneling effect to emit electrons into the vacuum even at normal temperature. This phenomenon is referred to as “field emission”, and a cathode (electron emitting device) which emits electrons due to this phenomenon is referred to as a “field emission cathode”. In recent years, a FED (Field Emission Display) has attracted attention as a flat display in which a plurality of micron-size field emission cathodes is formed on a substrate by a semiconductor processing technique. In the FED, electrons are emitted from electrically selected (addressed) emitters by concentration of an electric field and collided with a phosphor on the anode substrate side to display an image by excitation and luminescence of the phosphor.

Also, an emitter structure using carbon nanotubes, which can provide numerous sharp tips, have recently been proposed as a structure of the field emission cathode. The carbon nanotubes generally have a high aspect ratio and have tips with a very low radius of curvature. Therefore, the carbon nanotubes have attracted attention as an emitter material (electron emission source) capable of realizing high luminescence efficiency.

Since the carbon nanotubes are very fine particles (powder), the formation of an emitter using the carbon nanotubes requires bonding of the carbon nanotubes to a substrate. The bonding of the carbon nanotubes generally uses a binder material with high conductivity, such as silver paste, an ITO (Indium Tin Oxide) solution, or the like. Specifically, the carbon nanotubes are mixed in the binder material to form paste (or slurry or ink), and the resulting paste is applied to a surface of a substrate by a method, such as printing, spraying, die coating, or the like to bond the carbon nanotubes to the substrate using the adhesiveness of the binder material.

With respect to the application of a paste material containing carbon nanotubes, for example, Japanese Unexamined Patent Application Publication No. 2000-63726 (pages 2 and 3 and FIG. 2) discloses that conductive paste includes a vehicle containing a resin dissolved in an organic solvent and a plurality of carbon nanotubes dispersed in the vehicle, the carbon nanotubes each including a cylindrical graphite layer, and the conductive paste is used for forming an anode electrode on which a phosphor layer of a fluorescent display is formed.

With, respect to a process for forming an emitter using carbon nanotubes, for example, Japanese Unexamined Patent Application Publication No. 2001-35369 (pages 2, 4, and 5, and FIGS. 1 to 4) discloses a process for manufacturing an electron emission source including the steps of bonding a cathode conductor to an insulating substrate, applying a paste material containing at least one of carbon nanotubes, fullerene, nanoparticles, nanocapsules, and carbon nanohorns to the cathode conductor to form a carbon layer, attaching an adhesive tape to the carbon layer and then peeling the adhesive tape therefrom to form an emitter, and forming a gate electrode at a distance from the emitter.

Also, Japanese Unexamined Patent Application Publication No. 2002-197965 (pages 2 and 18, and FIG. 5) discloses a process for manufacturing a cold-cathode field electron emitting device including the steps of forming a cathode electrode on a support, forming an insulating layer on the support and the cathode electrode, forming a gate electrode having an opening on the insulating layer, forming an second opening in the insulating layer so that the second opening communicates with the opening formed in the gate electrode, forming a metal thin film or an organometallic compound thin film on a portion of the surface of the cathode electrode at the bottom of the second opening to form a selective growth region for a carbon thin film, and forming a carbon thin film on the selective growth region for the carbon thin film.

Furthermore, Japanese Unexamined Patent Application Publication No. 2001-43790 (pages 2 and 7 to 10, and FIGS. 1 to 9) discloses a process for manufacturing a cold-cathode field electron emitting device including the steps of forming a cathode on a support, forming an insulating layer on the support including the cathode electrode, forming a gate electrode on the insulating layer, forming an opening in at least the insulating layer so that the cathode electrode is exposed at the bottom of the opening, forming an electron emitting electrode including a conductive composition containing conductive particles and a binder on the cathode electrode exposed at the bottom of the opening, and removing the binder from a surface layer of the electron emitting electrode to expose the conductive particles from the surface of the electron emitting electrode.

In a process for manufacturing an electron emitting device including forming an emitter layer on a cathode electrode using carbon nanotubes, forming an insulating layer and a gate electrode on the emitter layer, and then forming a gate hole in the insulating layer and the gate electrode by boring, boring by etching the insulating layer may greatly damage the emitter layer.

A possible measure against this damage includes forming a protection layer on the emitter layer using a material having a good etching selectivity between the material and the insulating layer, and forming the insulating layer on the protection film, thereby avoiding damage to the emitter layer due to bring.

However, in the process for manufacturing an electron emitting device, the surface of the emitter layer must be finally exposed in the gate hole, and thus the protection layer is removed. As a material for forming the protection layer, chromium (Cr) is used in view of etching selectivity between the material and SiO₂ frequently used for insulating layers. In this case, when the chromium protection layer is removed from the surface of the emitter layer within the gate hole, for example, a strong acid such as a mixed acid containing cerium (IV) ammonium nitrate and perchloric acid is frequently used. Therefore, the manufacturing process has the disadvantage that in removing the protection layer by etching, the surface of the emitter is corroded by the strong dissolving action of the strong acid to easily cause large damage to carbon nanotubes.

The present invention has been achieved for solving the above-described problem, and is aimed at providing a process for manufacturing an electron emitting device which is capable of decreasing damage to an emitter material (carbon nanotubes, or the like) in removal of a protection film, and also providing a process for manufacturing a display including an electron emitting device.

### DISCLOSURE OF INVENTION

A for manufacturing an electron emitting device according to the present invention includes a first step of forming an emitter layer containing a fibrous emitter material on a cathode electrode, a second step of forming a functional layer on the emitter layer through a protection film, a third step of forming a hole in the functional layer above the emitter layer, and a fourth step of removing the protection film, which was exposed by hole formation, with a weak acid etchant.

The process for manufacturing an electron emitting device uses the weak acid etchant having weaker dissolving power than a strong acid for etching off the protection film exposed by hole formation so that only the protection film can be securely removed by dissolution while suppressing etching corrosion of the emitter layer.

### BRIEF DESCRIPTION OF THE DRAWINGS

FIG. 1 is a sectional view showing an example of a panel structure of a display to which the present invention is applied.

FIG. 2 is a perspective view showing an example of a panel structure of a display to which the present invention is applied.

FIGS. 3A to 3F are drawings (1) showing steps of an example of a process for manufacturing an electron emitting device according to an embodiment of the present invention.

FIGS. 4A to 4C are drawings (2) showing steps of an example of a process for manufacturing an electron emitting device according to an embodiment of the present invention.

FIGS. 5A to 5C are drawings (3) showing steps of an example of a process for manufacturing an electron emitting device according to an embodiment of the present invention.

### BEST MODE FOR CARRYING OUT THE INVENTION

An embodiment of the present invention will be described in detail below with reference to the drawings.

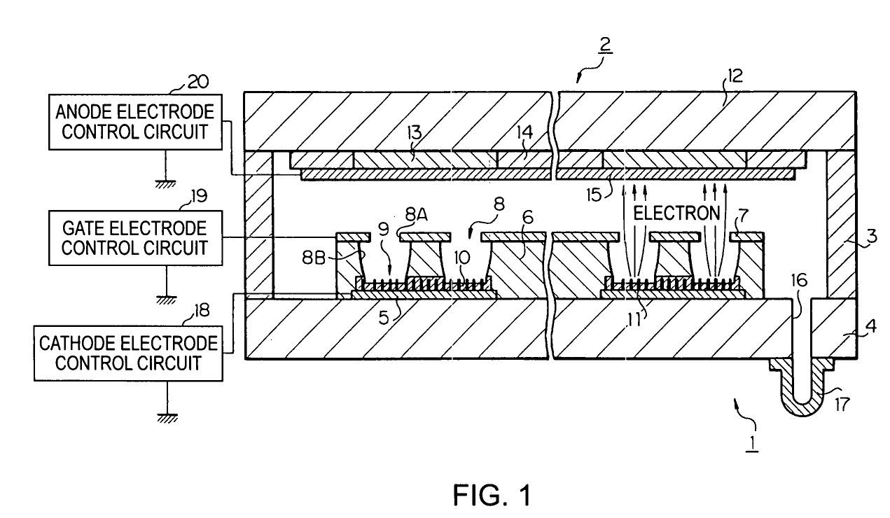

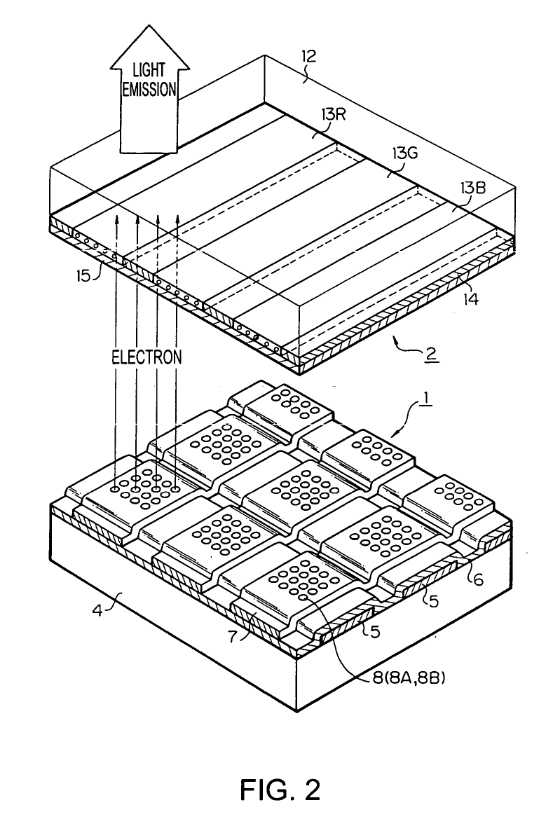

FIG. 1 is a sectional view showing an example of a panel structure of a display to which the present invention is applied, and FIG. 2 is a perspective view of the same. In FIGS. 1 and 2, a cathode panel (cathode substrate) 1 and an anode panel (anode substrate) 2 are opposed to each other with a predetermined distance therebetween, and both substrates 1 and 2 are integrally combined with a frame 3 to form a panel structure (display panel) for displaying an image.

Also, a plurality of electron emitting devices is formed on the cathode substrate 1. The plurality of electron emitting devices is formed in a two-dimensional matrix in an effective region (actually functioning as a display region) of the cathode substrate 1. Each of the electron emitting devices includes an insulating support substrate (for example, a glass substrate) 4 used as a base of the cathode substrate 1, a cathode electrode 5, an insulating layer 6, and a gate electrode 7 which are laminated on the support substrate 4 in that order, gate holes 8 formed in the gate electrode 7 and the insulating layer 6, and electron emission portions 9 formed at the bottoms of the gate holes 8.

The cathode electrodes 5 are formed in stripes to form a plurality of cathode lines. The gate electrodes 7 are formed in stripes to form a plurality of gate lines perpendicular (intersecting at right angles) to the cathode lines. The each of the gate holes 8 includes a first opening 8A formed in the corresponding gate electrode 7 and a second opening 8B formed in the corresponding insulating layer 6 so as to communicate with the first opening 8A.

Each of the electron emission portions 9 includes an emitter layer 10 mainly containing a fibrous emitter material and a binder material (matrix). In the emitter layer 10, a plurality of carbon nanotubes 11 used as the fibrous emitter material is arranged on the surface thereof.

One of the ends of each carbon nanotubes 11 projects perpendicularly from the surface of the emitter layer 10, and the other end is buried in the binder material of the emitter layer 10.

Each carbon nanotube 11 has a one- or two-layer cylindrical shape formed by rounding a graphene sheet and is a material having a diameter of about 0.7 to 50 nm and a length of several μm and thus having a high aspect ratio. The carbon nanotubes 11 are a material having a very sharp edge and can thus provide an electron emitting device having excellent electron emission characteristics when used as an emitter material. However, an emitter material other than the carbon nanotubes 11 may be used as long as it is a fibrous micro-substance usable as an emitter material.

On the other hand, the anode substrate 2 includes a transparent substrate 12 serving as a base, a phosphor layer 13 and a black matrix 14 which are formed on the transparent substrate, and an anode electrode 15 formed on the transparent substrate 12 to cover the phosphor layer 13 and the black matrix 14. The phosphor layer 13 includes a phosphor layer 13R for red luminescence, and a phosphor layer 13G for green luminescence, and a phosphor layer 13B for blue luminescence. The black matrix 14 is formed between the phosphor layers 13R, 13G, and 13B for the respective color luminescenes. The anode electrode 15 is laminated over the entire effective region of the anode substrate 2 so as to oppose to the electron emitting devices on the cathode substrate 1.

The cathode substrate 1 and the anode substrate 2 are bonded together with a frame 3 provided therebetween at the peripheries (edges) thereof. In an ineffective region (not functioning as a display portion outside the effective region) of the cathode substrate 1, a through hole 16 for evacuation is provided. The through hole 16 is connected to a tip tube 17 which is sealed after evacuation. However, FIG. 1 shows the display device in a completely assembled state in which the tip tube 17 is sealed. FIGS. 1 and 2 do not show a pressure proof support (spacer) which is inserted in the gap between the substrates 1 and 2.

In the display having the above-described panel structure, a relatively negative voltage is applied to the cathode electrodes 5 from a cathode electrode control circuit 18, a relatively positive voltage is applied to the gate electrodes 7 from a gate electrode control circuit 19, and a positive voltage higher than that applied to the gate electrodes 7 is applied to the anode electrode 15 from an anode electrode control circuit 20. In an actual image display on the above-described display, for example, a scanning signal is input to the cathode electrodes 5 from the cathode electrode control circuit 18, and a video signal is input to the gate electrodes 7 from the gate electrode control circuit 19. Alternatively, a video signal is input to the cathode electrodes 5 from the cathode electrode control circuit 18, and a scanning signal is input to the gate electrodes 7 from the gate electrode control circuit 19.

As a result, a voltage is applied between the cathode electrodes 5 and the gate electrodes 7 to concentrate an electric field in the sharp portions (the tips of the carbon nanotubes 11) of the electron emitting portions 9, so that electrons pass through an energy barrier due to a quantum tunneling effect and are emitted into a vacuum from the electron emitting portions 9. The emitted electrons are attracted by the anode electrode 15 and moved toward the anode substrate 2 to collide with the phosphor layer 13 (13R, 13G, and 13B) on the transparent substrate 12. As a result, the phosphor layer 13 is excited by the collision of the electrons to emit light, and thereby a desired image can be displayed on the display panel by controlling the luminescence positions in pixel units.

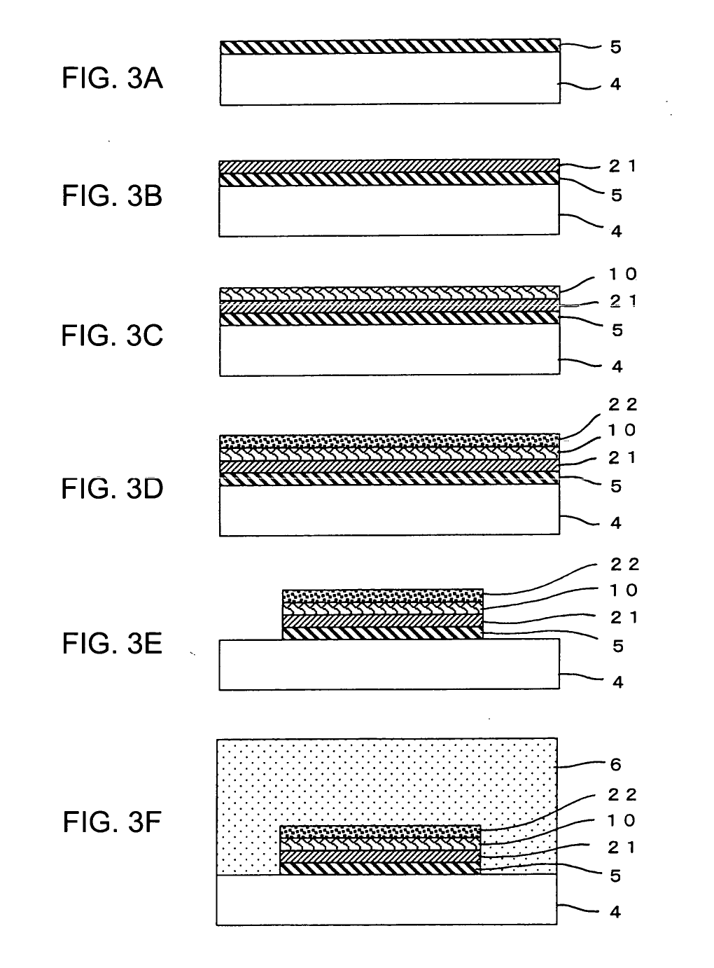

Next, description will be made of a process for manufacturing an electron emitting device according to an embodiment of the present invention with reference to FIGS. 3A to 3F, 4A to 4C, and 5A to 5C.

First, as shown in FIG. 3A, a cathode electrode (conductive layer) 5 is formed on a support substrate 4 serving as a base of a cathode substrate 1 using a conductive material for forming a cathode electrode.

The cathode electrode 5 is formed using a chromium layer of about 0.2 μm in thickness which is formed by, for example, sputtering.

Next, a SiCN film is deposited over the entire surface of the support substrate 4 by sputtering to form a resistance layer 21 of about 0.2 μm in thickness including the SiCN film and covering the cathode electrode 5 as shown in FIG. 3B. When a discharge current to the emitter is increased, the resistance layer 21 functions to decrease the effective voltage applied to an emitter by increasing a voltage drop due to resistance. Conversely, when the discharge current to the emitter is decreased, the resistance layer 21 functions to increase the effective voltage applied to the emitter. In this way, the resistance layer 21 functions to stabilize the discharge current. The resistance layer 21 is formed according to demand.

Next, a treatment is performed for disposing carbon nanotubes 11 serving as an emitter material on the resistance layer 21 (on the cathode electrode 5 when the resistance layer 21 is not formed).

Specifically, thermal decomposable organometals, organic tin and organic indium, are used as binder materials, and a powder of carbon nanotubes is used as an emitter material. These materials are dispersed in a volatile solvent, e.g., butyl acetate, under the conditions below to prepare a mixed solution. In this step, ultrasonic treatment may be performed for improving the dispersibility of the carbon nanotubes. The diluent used may be aqueous or non-aqueous on the assumption that the dispersant used depends on the type of the diluent used. Furthermore, other additive may be mixed. The carbon nanotubes have a very long and thin tube structure (fibrous) having an average diameter of 1 nm and an average length of 1 μm, and can be formed by, for example, arm discharge.

(Preparation Conditions for Mixed Solution)

Organic tin and organic indium: 10 to 50% by mass

Butyl acetate: 30 to 80% by mass

Dispersant (for example, sodium dodecylsulfate): 0.1 to 5% by mass

Carbon nanotubes: 0.01 to 20% by mass

Filler (silica): 1 to 80% by mass

As the emitter material, carbon nanofibers may be used in place of the carbon nanotubes. As the binder material, metal salts, such as tin chloride and indium chloride, may be used in place of the thermal decomposable organometals.

Next, the mixed solution is applied on the support substrate 4 by spraying or the like to form an emitter layer 10 containing a plurality (many) of the carbon nanotubes and the binder materials, as shown in FIG. 3C. The spraying is performed in an atmosphere of a temperature higher than room temperature, for example, a relatively high temperature of 50° C. Namely, dry spraying is used so that the emitter layer 10 quickly becomes dried on the support substrate 4. Therefore, the process can be transferred to a next step without any particular drying treatment (e.g., heating, blowing, or the like).

The emitter layer 10 can also be formed by printing. In the printing, paste used as a material for forming the emitter layer 10 has appropriate viscosity, and thus the process can be transferred to the next step without any particular drying treatment as in the dry spraying. However, in printing using a low-viscosity coating material or in wet spraying, it is desirable to perform the next step after drying treatment or after the surface of the emitter layer is dried.

Next, as shown in FIG. 3D, a protection film 22 is formed on the emitter layer 10. The protection film 22 is provided as a so-called etching stop layer for protecting the emitter layer 10 from corrosion by etching for forming a hole in a functional layer above the emitter layer 10. Herein, an insulating layer 6 is formed as the functional layer. The protection film 22 can be formed by a deposition method, such as sputtering, vapor deposition, CVD (Chemical Vapor Deposition), coating, or the like. In the coating, a sol-gel solution can be used.

The protection film 22 is formed using a material which can be removed by dissolution with a weak acid etchant. Specifically, the protection film 22 is formed using, for example, titanium, magnesium, copper, zinc, molybdenum, nickel, cobalt, iron, indium, tin, or an alloy or an oxide film thereof, or ITO. In particular, when the protection film 22 is formed using a metal oxide film (e.g., MgO), the protection film 22 can be removed with a weak acid etchant, which will be described below, with high processability (resolution).

Then, the emitter layer 10 is baked under the conditions below. As a result, the organic components are evaporated to obtain the solidified emitter layer 10 in which the carbon nanotubes are buried in the binder material. When the protection film 22 is formed on the emitter layer 10 by coating, the emitter layer 10 and the protection film 22 are simultaneously baked.

(Baking conditions)

Atmosphere: air

Baking temperature: 500° C.

Baking time: 30 minutes

Next, the protection film 22, the emitter layer 10, the resistance layer 21, and the cathode electrode 5 are patterned by a known lithography and wet etching or dry etching such as reactive ion etching (RIE) or the like to form the protective film 22, the emitter layer 10, the resistance layer 21, and the cathode electrode 5 in stripes on the support substrate 4, as shown in FIG. 3E.

Next, as shown in FIG. 3F, the insulating layer 6 is formed over the support substrate 4 to cover a laminate of the cathode electrode 5, the resistance layer 21, the emitter layer 10, and the protection film 22. Specifically, the insulating film 6 composed of, for example, SiO₂, is formed to a thickness of about 1 μm over the entire surface of the support substrate 4 by CVD using TEOS (tetraethoxysilane) as a raw material gas.

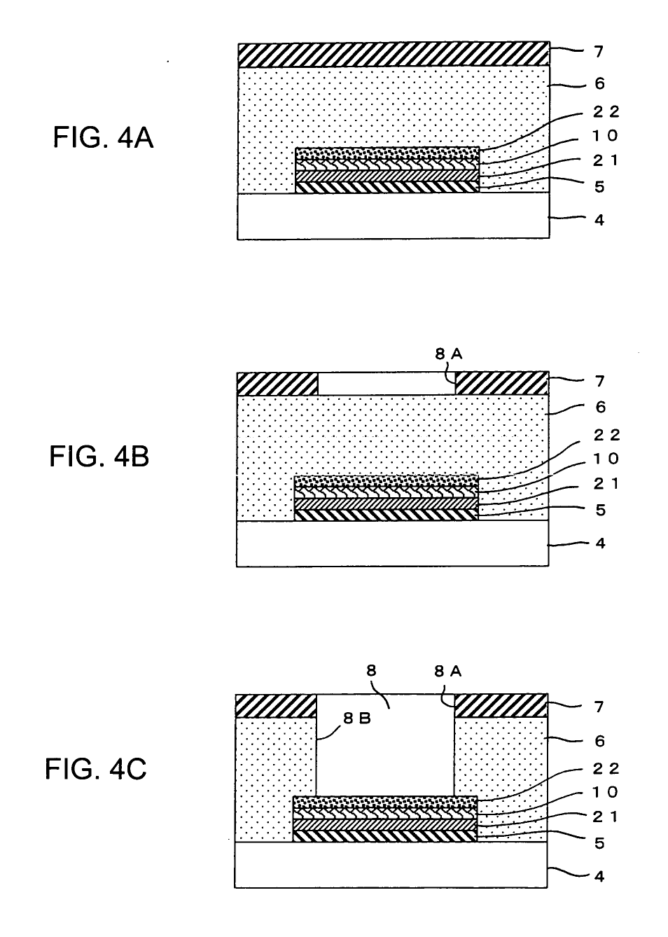

Next, as shown in FIG. 4A, a gate electrode (conductive layer) 7 is formed on the insulating layer 6 on the support substrate 4 using a conductive material for forming a gate electrode. Specifically, the gate electrode 7 including a chromium layer is formed on the insulating layer 6 by sputtering.

Next, an etching mask (not shown in the drawing) is formed on the gate electrode 7, and predetermined portions of the gate electrode 7 are etched through the etching mask to form the gate electrode 7 in a stripe on the insulating layer 6 and form first openings 8A passing through the gate electrode 7, as shown in FIG. 4B.

Next, as shown in FIG. 4(C), the insulating layer 6 is etched (hole formation) by RIE through the first openings 8A of the gate electrode 7 to form second openings 8B in the insulating layer 6, thereby exposing the surface of the protective film 22. In hole formation by etching, the surface of the emitter layer 10 is protected by the protection film 22.

As a result, gate holes 8 each including the first opening 8A and the second opening 8B are formed in the gate electrode 7 and the insulating layer 6 which are disposed above the emitter layer 10. The gate holes 8 are formed in, for example, a circular shape having a diameter of 20 μm, and a plurality (for example, several tens) of the gate holes 8 is formed per pixel.

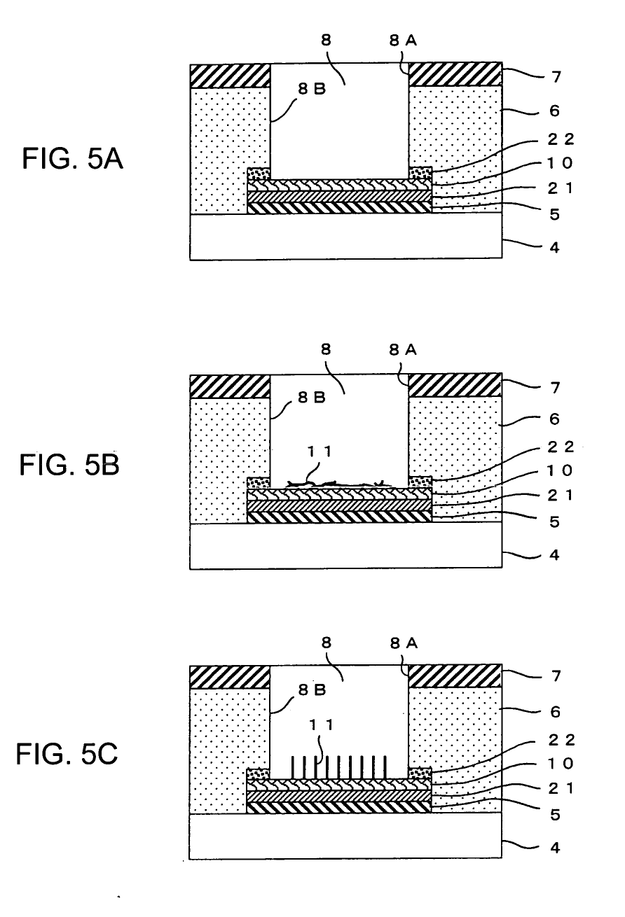

Next, the protection film 22 is removed by etching through the gate holes 8 to expose the surface of the emitter layer 10 at the bottoms of the gate holes 8, as shown in FIG. 5A. In this step, the protection film 22 is etched (wet etching) with a weak acid etchant so that corrosion of the emitter layer 10 can be suppressed. Namely, use of the weak acid etchant decreases the chemical dissolution function as compared with use of a strong acid etchant. Therefore, only the protection film 22 can be securely removed by dissolution while effectively suppressing corrosion of the emitter layer 10. Consequently, damage to the carbon nanotubes 11 due to etching removal of the protection film 22 can be decreased.

The weak acid used as the etchant contains at least one of nitric acid, hydrochloric acid, sulfuric acid, and acetic acid. When nitric acid among these acids is used as the weak acid, the concentration of nitric acid in the etchant is 50% by mass or less, while when hydrochloric acid is used as the weak acid, the concentration of hydrochloric acid in the etchant is 40% by mass or less. When sulfuric acid is used as the weak acid, the concentration of sulfuric acid in the etchant is 40% by mass or less, while when acetic acid is used as the weak acid, the concentration of acetic acid in the etchant is 40% by mass or less. In experiments conducted by the inventors of the present invention, it was confirmed that the protection film 22 deposited using MgO can be appropriately removed with an etchant containing 13% by mass of nitric acid.

Next, the binder material (matrix) is removed from an upper layer of the emitter layer 10 to expose the carbon nanotubes 11 from the surface of the emitter layer 10 at the bottoms of the gate holes 8, as shown in FIG. 5B. As a method for removing the binder material from an upper layer of the emitter layer 10, etching (half etching) such as wet etching or dry etching can be preferably used. As an example, the conditions of wet etching are given below.

(Wet etching conditions)

Etchant: HCl 10%

Etching temperature: 10 to 60° C.

Etching time: 5 to 60 seconds

Then, as shown in FIG. 5C, the carbon nanotubes 11 are oriented so as to uniformly rise substantially perpendicularly on the surface of the emitter layer 10. Specifically, for example, an adhesive tape (not shown) is attached to the gate electrode 7 formed on the support substrate 4, and then the adhesive tape is peeled to orient the carbon nanotubes 11 substantially perpendicularly to the support substrate 4.

### INDUSTRIAL APPLICABILITY

A described above, according to the present invention, a protection film exposed by hole formation is removed with a weak acid etchant, thereby decreasing damage to an emitter material contained in an emitter layer. As a result, an electron emitting device with excellent electron emission characteristics can be manufactured.

1. A process for manufacturing an electron emitting device comprising:
a first step of forming an emitter layer containing a fibrous emitter material on a cathode electrode;
a second step of forming a functional layer on the emitter layer through a protection film;
a third step of forming a hole in the functional layer above the emitter layer; and
a fourth step of removing the protection film, which was exposed by hole formation, with a weak acid etchant.

2. The process according to claim 1, wherein the functional layer is composed of SiO₂.

3. The process according to claim 1, wherein the protection film is composed of titanium, magnesium, copper, zinc, molybdenum, nickel, cobalt, iron, indium, tin, an alloy or oxide thereof, or ITO.

4. The process according to claim 1, wherein the protection film is composed of MgO.

5. The process according to claim 1, wherein the weak acid contains at least one of nitric acid, hydrochloric acid, sulfuric acid, and acetic acid.

6. A process for manufacturing a display including an electron emitting device, the process comprising:
a first step of forming an emitter layer containing a fibrous emitter material on a cathode electrode;
a second step of forming a functional layer on the emitter layer with a protection film provided therebetween;
a third step of forming a hole in the functional layer above the emitter layer; and
a fourth step of removing the protection film, which was exposed by hole formation, with a weak acid etchant.

7. The process according to claim 5, wherein the functional layer is composed of SiO₂.

8. The process according to claim 5, wherein the protection film is composed of titanium, magnesium, copper, zinc, molybdenum, nickel, cobalt, iron, indium, tin, an alloy or oxide thereof, or ITO.

9. The process according to claim 5, wherein the protection film is composed of MgO.

10. The process according to claim 5, wherein the weak acid contains at least one of nitric acid, hydrochloric acid, sulfuric acid, and acetic acid.
